(19) United States
(12) Patent Application Publication
(10) Pub. No.: US 2016/0000539 A1
(43) Pub. Date: Jan. 7, 2016

(54) METHOD FOR PRODUCING A PROTHESIS BASE

(71) Applicant: AMANN GIRRBACH AG, Koblach (AT)

(72) Inventor: Ineke Knill, Dornbirn (AT)

(73) Assignee: AMANN GIRRBACH AG, Koblach (AT)

(21) Appl. No.: 14/771,350

(22) PCT Filed: Feb. 6, 2014
(86) PCT No.: PCT/AT2014/000024

§ 371 Date: Aug. 28, 2015

(30) Foreign Application Priority Data
Mar. 7, 2013 (DE) 10 2013 003 913.4

(51) Int. Cl. A61C 13/20; A61C 13/01

(52) U.S. Cl. CPC A61C 13/20; A61C 13/04

(57) ABSTRACT

A method for producing a prosthesis base (1) from plastic material for a full or partial dental prosthesis (2), in which the prosthesis base (1) has prosthesis base receiving openings (3) for artificial teeth (4) and is produced on based on a digital data set which reflects a shape of the prosthesis base (1) having the prosthesis base receiving openings (3). On the basis of this digital data set first a wax temporary prosthesis (6) having corresponding wax temporary receiving openings (7) for the artificial teeth (4) is made, and subsequently the prosthesis base (1) is made using the wax temporary prosthesis (6).

### BACKGROUND

The present invention relates to a method for producing a prosthesis base from plastic for a full or partial dental prosthesis, wherein the prosthesis base has prosthesis base receiving openings for artificial teeth and is produced on the basis of a digital data set that reflects a shape of the prosthesis base with the prosthesis base receiving openings.

Full or partial dental prostheses are in principle formed of at least two different components. These are, on the one hand, a prosthesis base which replaces the gum regions that the patient has lost, and, on the other hand, artificial teeth which function as a replacement for the natural teeth that the patient has lost. The artificial teeth in the full or partial prosthesis are connected to the prosthesis base and have both therapeutic and also aesthetic functions. A full prosthesis replaces all the teeth of a patient's jaw. A partial prosthesis replaces only some of them. Artificial teeth are sold by various manufacturers. The commercially available prosthetic teeth are prefabricated shapes that vary in their colors. Prefabricated tooth shapes are commercially available in different sizes and are selected by the dental technician according to certain individual characteristics of the patient, e.g. the available space, height, sex and build. The prosthesis base, produced or to be produced from plastic, has to match exactly to the edentulous or partly edentulous dental arch of the patient and must take into account the individual circumstances within the patient's mouth. Full or partial prostheses are provided both for the upper jaw and also for the lower jaw.

In dentistry in general, there has in recent years been an increasing trend toward automated or computer-controlled production of tooth replacements. Thus, in the prior art, there have also already been various proposals as to how methods of the type in question can be carried out. Thus, EP 1 444 965 B1 proposes that the prosthesis base is produced directly using said digital data set and is subsequently fitted with prefabricated teeth. An at least similar approach is also described in DE 40 25 728 A1. Here, in each of the different variants, provision is always made that this digital data set is used to mill out so-called registrate bases from a block of plastic, in order to set up the teeth thereon in subsequent steps.

In said prior art, provision is therefore always made that a prosthesis base or at least a registrate base is produced immediately from plastic using said data set. However, this has the disadvantage that there are only limited possibilities as to how the prosthesis base or the registrate base can be adapted in detail or precisely tailored to the situation within the oral cavity of the patient. For this adaptation, all that can be done is to carry out a machining procedure in which unwanted areas of the prosthesis base or of the registrate base can be removed but missing parts can never be added.

### SUMMARY

The object is therefore to provide a novel embodiment of the methods in question, i.e. one that improves the possibilities of producing an optimally adapted prosthesis base.

This object is achieved in a method with one or more features of the invention.

Provision is thus made that, on the basis of the digital data set, a wax temporary prosthesis with corresponding wax temporary prosthesis receiving openings for the artificial teeth is first of all prepared, after which the prosthesis base is prepared using the wax temporary prosthesis.

It is therefore an underlying concept of the invention that the data set, which reflects a shape of the prosthesis base with the prosthesis base receiving openings, is used to produce not the prosthesis base itself directly but instead, as an intermediate step, a wax temporary prosthesis with the corresponding wax temporary prosthesis receiving openings for the artificial teeth. This wax temporary prosthesis affords the possibility that the accuracy of the fit can be checked in the patient's mouth or, in the absence of the patient, on a corresponding plaster impression. If it is found that the fit is already optimal, the wax temporary prosthesis can then be used, without further machining, to prepare the prosthesis base. If it is found in said test that the fit still needs to be optimized, the wax temporary prosthesis can be reshaped, e.g. after first being heated, or can also be machined by milling or also by additive or generative methods such that an optimum fit is obtained. In this case, the wax temporary prosthesis with the optimized fit can then be used to prepare the prosthesis base. An advantage of the intermediate step according to the invention, in the form of the wax temporary prosthesis, is principally that the wax temporary prosthesis prepared using the distal data set can be adapted to the desired optimal shape better than a plastic prosthesis base produced according to the prior art from the digital data set.

There are various possible ways of preparing the prosthesis. For example, provision can be made that the wax temporary prosthesis with the corresponding wax temporary prosthesis openings for the artificial teeth is milled with a milling machine on the basis of the digital data set. Alternatively, however, provision can also be made that the wax temporary prosthesis with the corresponding wax temporary prosthesis receiving openings for the artificial teeth is produced by a generative method on the basis of the digital data set. Suitable generative methods are known per se in the prior art. There are methods in which the body to be created, in this case the wax temporary prosthesis, is built up, if appropriate in multiple layers. An example that may be mentioned here is one in which the wax temporary prosthesis with the wax temporary prosthesis receiving openings is built up on the basis of the digital data set, using a 3D plotter or 3D printer, from generally liquid wax. Examples of suitable generative methods also include selective laser melting and stereolithography. It should be noted in this context that the wax temporary prosthesis produced according to the invention always already has the wax temporary prosthesis receiving openings and always has the shape of the entire data set, which has the shape of a prosthesis base with its prosthesis base receiving openings. The wax temporary prosthesis thus also has at least one surface that serves to bear on the gum in the state when inserted into the patient's mouth.

There are likewise various possible ways to prepare the prosthesis base using the wax temporary prosthesis. A first possibility, for example, involves copy milling, which is known per se. It is equally possible to scan in the wax temporary prosthesis and then, on the basis of the data set thus generated, to prepare the prosthesis base, e.g. in a computer-controlled milling procedure, or to build up the prosthesis base with the prosthesis base receiving openings from plastic using a generative method, e.g. one of the generative methods mentioned by way of example above in connection with the wax temporary prosthesis. However, in particularly preferred embodiments of the invention, provision is made that the prosthesis base with or without the artificial teeth arranged in the prosthesis base receiving openings is produced, using the wax temporary prosthesis with or without the artificial teeth arranged in the wax temporary prosthesis receiving openings, in a casting process or in a plugging process. For this purpose, plastic casting or plugging methods customary in dentistry can be used. Provision can be made that the artificial teeth are inserted into the wax temporary prosthesis receiving openings before the prosthesis base is prepared. In preferred variants, provision is in turn made that the prosthesis base with artificial teeth inserted into the prosthesis base receiving openings is prepared using the wax temporary prosthesis with artificial teeth inserted into the wax temporary prosthesis receiving openings.

The artificial teeth can be prefabricated products that can be purchased commercially and, as long as their root is not too long, can be inserted without further machining into the wax temporary prosthesis receiving opening or the prosthesis base receiving opening. If the artificial teeth are too long, provision is made, in a preferred variant of the method according to the invention, that at least some of the artificial teeth, before their insertion into the wax temporary prosthesis receiving openings or the prosthesis base receiving openings, are shortened in their area that is to be arranged in the wax temporary prosthesis or in the prosthesis base. The area of the artificial tooth that is to be arranged in the wax temporary prosthesis or in the prosthesis base is its root area or neck area. In this preferred embodiment, this area is shortened prior to insertion. This can be done manually. The prior art in the form of DE 10 2011 101 678 A2, however, has already disclosed possible ways of how this shortening of the artificial teeth can be carried out in an automated manner or with computer control.

Procedures as described in the prior art can likewise be used to create the digital data set, on the basis of which the wax temporary prosthesis with the wax temporary prosthesis receiving openings for the artificial teeth is first of all milled with the milling machine. Such methods are described, for example, in the aforementioned prior art in the form of EP 1 444 965 A1.

Provision can thus be made that the shape of the partially or completely edentulous dental arches in the patient's mouth is first of all scanned in. Alternatively, it is also possible to create plaster models in a manner known per se by taking impressions of the upper and/or lower jaw of the patient, which models reflect the geometry of the upper and/or lower dental arch, in order then to scan these in if appropriate. The plaster models or the data sets of the dental arches generated by scanning are then articulated in a known manner either by an analog or digital procedure. Thereafter, in a likewise either analog or digital procedure, model analysis is performed. On the basis of the model analysis, the suitable artificial teeth are then selected and, in an analog or digital manner, are set up on the digital model or the analog plaster model of the upper an/or lower dental arch, from which, in a likewise digital or analog manner, the shape or the data set is generated that reflects the shape of the prosthesis base to be generated with the prosthesis base receiving openings.

### BRIEF DESCRIPTION OF THE DRAWINGS

Preferred variants of methods according to the invention are explained in more detail below in the description of the figures, in which:

FIG. 1 shows a CNC milling machine, known from the prior art, with control computer;

FIG. 2 shows a wax temporary prosthesis for the upper jaw without artificial teeth;

FIG. 3 shows a wax temporary prosthesis for the lower jaw without artificial teeth;

FIG. 4 shows the wax temporary prosthesis from FIG. 2 with artificial teeth inserted into the wax temporary prosthesis receiving openings;

FIG. 5 shows the wax temporary prosthesis from FIG. 3 with artificial teeth inserted into the wax temporary prosthesis receiving openings;

FIG. 6 shows a schematic view of the casting mold prepared using the wax temporary prosthesis of the upper jaw with the artificial teeth as per FIG. 4;

FIG. 7 shows the same casting mold as FIG. 6, but with the wax temporary prosthesis having already been removed;

FIG. 8 shows the finished prosthesis base of the upper jaw with inserted artificial teeth;

FIG. 9 shows the finished prosthesis base of the lower jaw with inserted artificial teeth;

FIG. 10 shows the prosthesis base of the upper jaw without artificial teeth;

FIG. 11 shows the prosthesis base of the lower jaw without artificial teeth;

FIGS. 12 to 14 show schematic views of suitable generative methods.

### DETAILED DESCRIPTION OF THE PREFERRED EMBODIMENTS

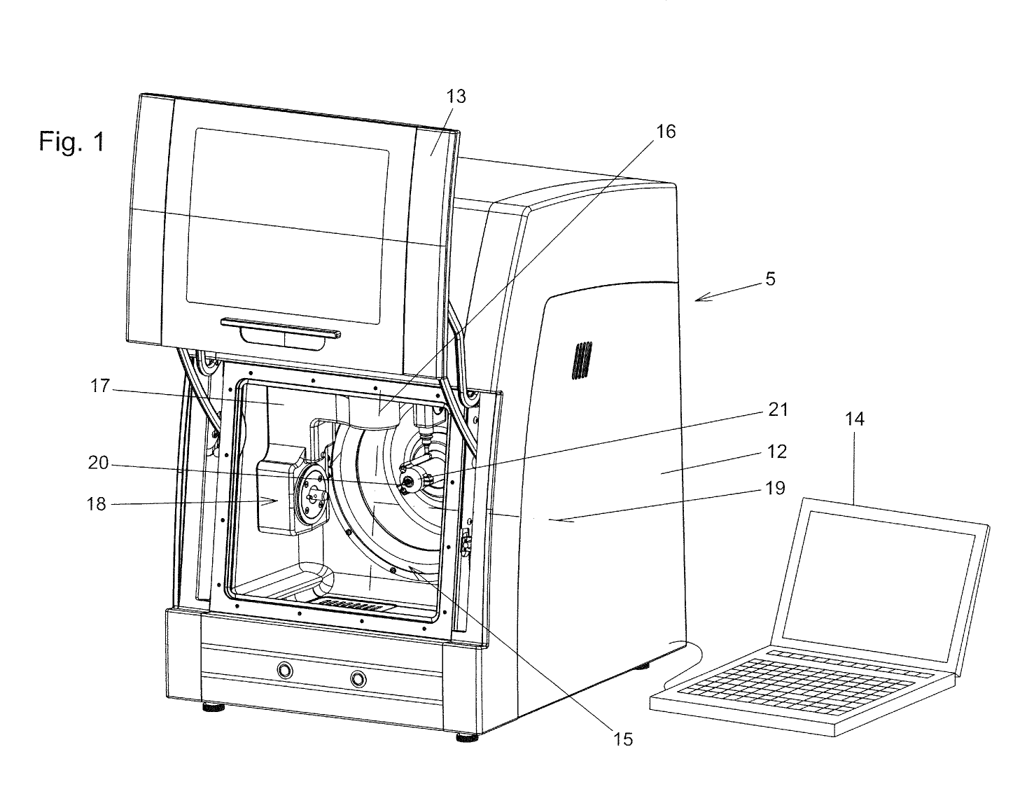

FIG. 1 shows a milling machine 5 in the form of a CNC milling machine which is known from the prior art and which is controlled by a control computer 14. The milling machine 5 has a housing 12 with a machining cavity 15. With the closure flap 13 opened, as shown in FIG. 1, the machining cavity 15 is accessible from the outside, and it can be closed, during the milling process, by suitable lowering of the closure flap 13. The milling process for producing the wax temporary prosthesis 6 with the wax temporary prosthesis receiving openings 7 for the artificial teeth 4 can be carried out in the machining cavity 15. For this purpose, the digital data set, which reflects a shape of the prosthesis base 1 to be produced with the prosthesis base receiving openings 3, will be loaded into the control computer 14, which transmits to the milling machine 15 the corresponding commands for the milling process for producing the wax temporary prosthesis 6. For the milling process, the wax blank (not shown here) is secured on the securing device 18 of the pivot arm 17 in a manner that is known per se but not shown here. In the illustrative embodiment shown, the wax blank is rotatable about the rotation axis 19. The pivot arm 17 is additionally pivotable about the pivot axis 16. The wax temporary prosthesis 6 is milled from the wax blank (not shown here) by means of the tool 20, which is secured on the tool carrier head 21 so as to be rotatable about its longitudinal axis. In the illustrative embodiment of the milling machine 5 shown, the tool carrier head 21 can be moved in all three spatial directions in the machining cavity 15. Such a milling process is known per se and does not need to be explained in any more detail here.

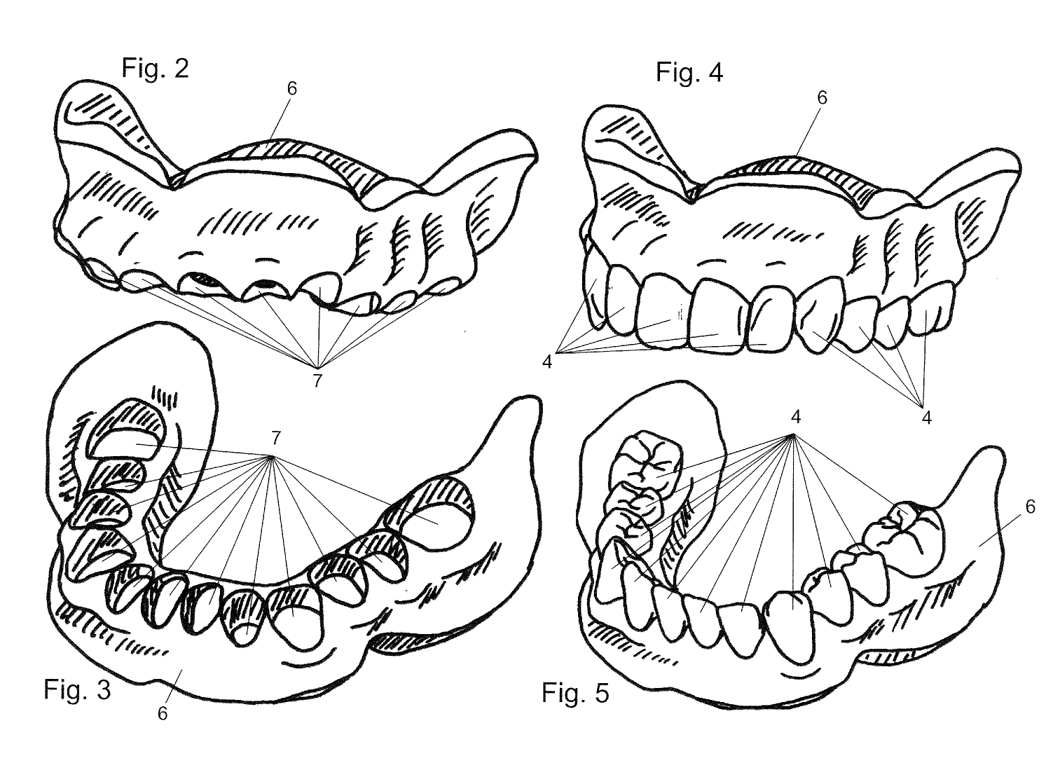

As a result of this milling process, the wax temporary prosthesis 6 with the wax temporary prosthesis receiving openings 7 for the artificial teeth 4 is obtained. FIG. 2 shows a corresponding wax temporary prosthesis 6 with the wax temporary prosthesis receiving openings 7 for the upper jaw. FIG. 3 shows a corresponding wax temporary prosthesis 6 with the wax temporary prosthesis receiving openings 7 for the lower jaw. In FIGS. 4 and 5, these wax temporary prostheses 6 are each shown with artificial teeth 4 already inserted into the wax temporary prosthesis receiving openings 7.

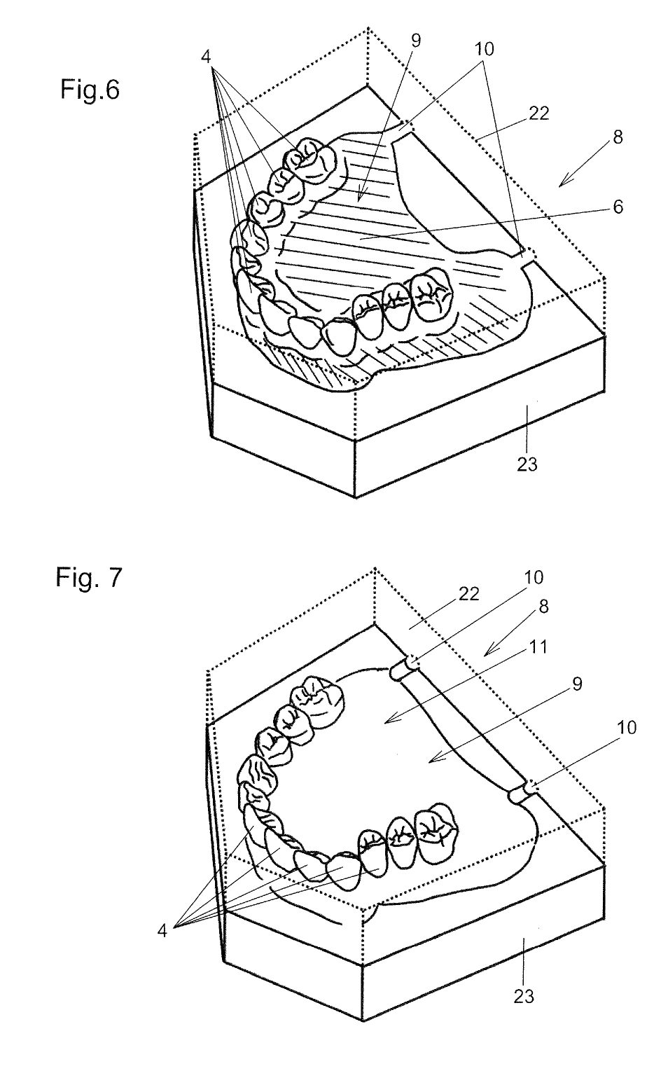

In a further method step of a preferred embodiment of the invention, the wax temporary prosthesis 6 with the artificial teeth 4 arranged therein is then used to produce a casting mold 8, of which the inner cavity 9 reflects the outer contour of the wax temporary prosthesis 6 with the artificial teeth 4 arranged in the wax temporary prosthesis receiving openings 7. FIG. 6 shows a schematic view of a corresponding casting mold 8 and, arranged therein, the wax temporary prosthesis 6 with the artificial teeth 4 as per FIG. 4. This is therefore the casting mold 8 for the prosthesis base 1 for the upper jaw. The production of the casting mold 8 for the lower jaw, using the wax temporary prosthesis 6 as per FIG. 5, takes place in a corresponding way and is not shown here. In the example shown here, the casting mold 8 is formed of an upper mold half 22 and of a lower mold half 23. In the first variant of the method according to the invention as described here, these two mold halves 22 and 23 remain closed until, as will be explained below, the finished prosthesis base 1 with the artificial teeth 4 arranged therein is removed.

The upper mold half 22 is shown as being transparent in FIGS. 6 and 7, so that the position of the inner cavity 9 can be discerned. The casting mold 8 or the upper and lower mold halves 22 and 23, respectively, form a negative impression of the wax temporary prosthesis 6 and of the artificial teeth 4 inserted therein. The mold halves 22 and 23 or the casting mold 8 can be produced from plaster or other suitable material by casting the wax temporary prosthesis 6 with inserted artificial teeth 4.

After the casting mold 8 has been produced, the wax temporary prosthesis 6 can be melted in the casting mold 8 and the resulting liquid wax can be drained off from the inner cavity 9 via overflow openings 10 of the casting mold 8. Provision is preferably made here that the artificial teeth 4 are maintained in their position in the inner cavity 9 by the casting mold 8 during and after the draining of the liquid wax from the inner cavity 9. FIG. 7 shows the situation in which the wax temporary prosthesis 6 is removed from the inner cavity 9 by melting and draining off the wax, but the artificial teeth 4 are still held in their original position by the casting mold 8. Proceeding from this situation, in order to form the prosthesis base 1, the volume 11 that has been freed within the inner cavity 9 by draining off the liquid wax can be filled with the plastic from which the subsequent prosthesis base 1 is made. Suitable plastics that are able to be cast and then hardened in order to form dental prosthesis bases are known in the prior art. As the volume 11 that has been freed is filled with the plastic, the artificial teeth 4 are also secured in the prosthesis base 1 at the same time. Once the plastic has suitably hardened, the casting mold 8 can be opened, e.g. by separating the upper and lower mold halves 22, 23, and the prosthesis base 1 together with the artificial teeth 4 arranged therein can thus be removed. If necessary, further working can be carried out on the prosthesis base 1 by means known in the prior art, e.g. by milling, e.g. in order to remove sprues from the overflow openings 10.

In the illustrative embodiment shown, the introduction of the liquid plastic into the inner cavity 9 takes place once again via the overflow openings 10. One of the overflow openings 10 can be used as a filler nozzle and the other overflow opening 10 can be used as a ventilation opening. The inner cavity 9 can also be filled with suitably liquid plastic via both overflow openings 10, in which case other ventilation openings (not shown here) may expediently be provided for the escape of the displaced gas or of the displaced air.

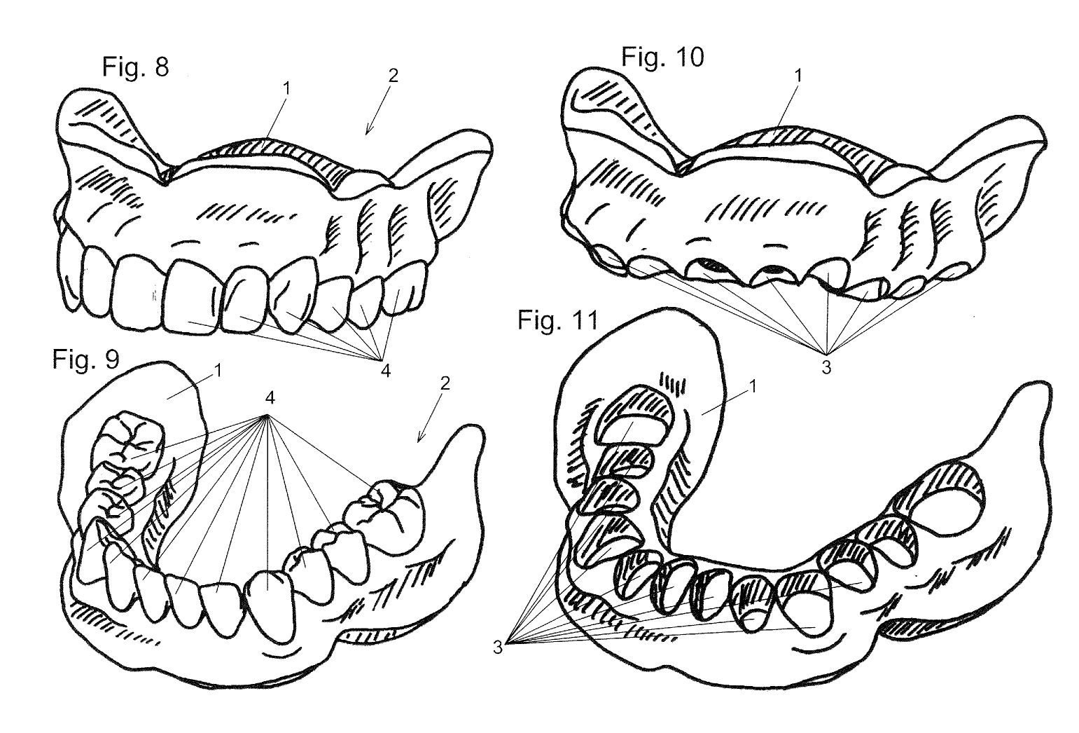

The finished prosthesis base 1 of the upper jaw, with the artificial teeth 4 already secured therein by the casting process, is shown in FIG. 8. This is a full prosthesis 2 comprised of the prosthesis base 1 and of the artificial teeth 4 arranged therein. FIG. 9 shows a full prosthesis 2 to be correspondingly produced, for which the wax temporary prosthesis 6 with artificial teeth 4 arranged therein as per FIG. 5 can be used as starting product.

In the variant described above, the casting process was carried out on the basis of the wax temporary prosthesis 6 with artificial teeth 4 inserted into the wax temporary prosthesis receiving openings 7. In principle, it is also possible to carry out a corresponding casting process based on the wax temporary prostheses 6 shown in FIG. 2 and/or FIG. 3 without the correspondingly inserted artificial teeth 4. This casting process results in the prosthesis bases 1 with the prosthesis base receiving openings 3 as shown in FIGS. 10 and 11. In these variants, the artificial teeth 4 can be inserted or bonded into the prosthesis base receiving openings 3 after the casting process, in order then once again to produce the full prostheses 2 as per FIGS. 8 and 9. If a casting mold 8 is produced using a wax temporary prosthesis 6 without the artificial teeth 4 arranged therein, the inner cavity 9 of the casting mold 8 reflects the outer contour of the wax temporary prosthesis 6 without the artificial teeth 4 arranged in the wax temporary prosthesis receiving openings 7. The wax temporary prosthesis 6 can then once again be removed accordingly from the inner cavity 9 by being melted and drained off through the overflow opening 10. In such embodiments, however, it is also conceivable to withdraw the wax temporary prosthesis 6 from the inner cavity 9 by separation of the upper and lower mold halves 22, 23. To form the prosthesis base 1 with the prosthesis base receiving openings 3 for the artificial teeth 4, the volume 11 that has been freed in the inner cavity 9 by draining off the liquid wax or by removing the wax temporary prosthesis 6 is then filled with the plastic or liquid plastic in the manner described above. After the plastic has hardened, the prosthesis base 1 shown in FIGS. 10 and 11 can then be correspondingly removed from the casting mold 8.

If necessary, the artificial teeth 4 can be shortened in the manner described at the outset. This takes place either before the artificial teeth 4 are inserted into the wax temporary prosthesis 6 or, in the casting process without artificial teeth 4, at the latest before the artificial teeth 4 are inserted into the prosthesis bases 1 as per FIG. 10 or 11.

As regards the further alternatives mentioned at the outset for preparation of the wax temporary prosthesis 6, and then of the prosthesis base 1 using the wax temporary prosthesis 6, no additional figures are provided here. As regards the production of the prosthesis base 1 using the wax temporary prosthesis 6, suitable copy milling devices are likewise known from the prior art, like the copy milling process itself The same also applies ultimately for the variant in which the wax temporary prosthesis 6 is scanned in and then, on the basis of this assembled data set, the prosthesis base 1 is then milled or is generated by means of generative methods. Suitable scanners are likewise known, like the milling machine shown by way of example in FIG. 1, or the aforementioned appliances for carrying out generative production methods.

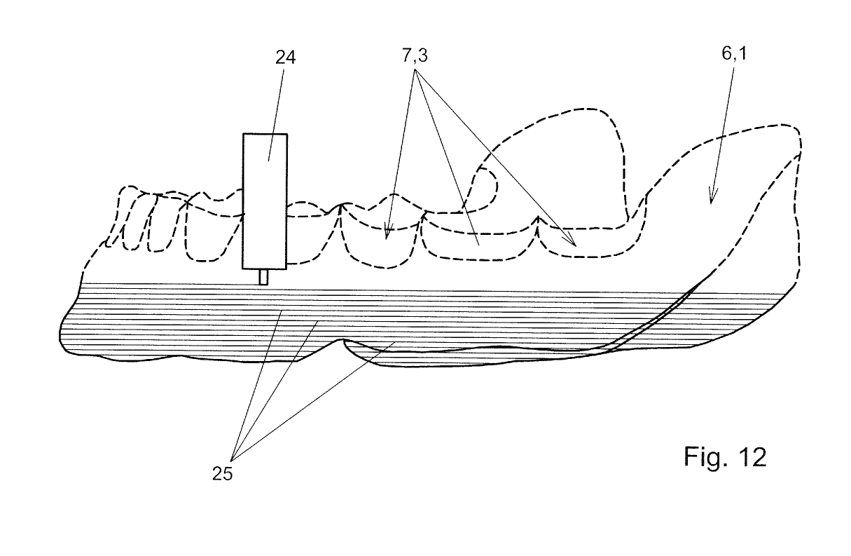

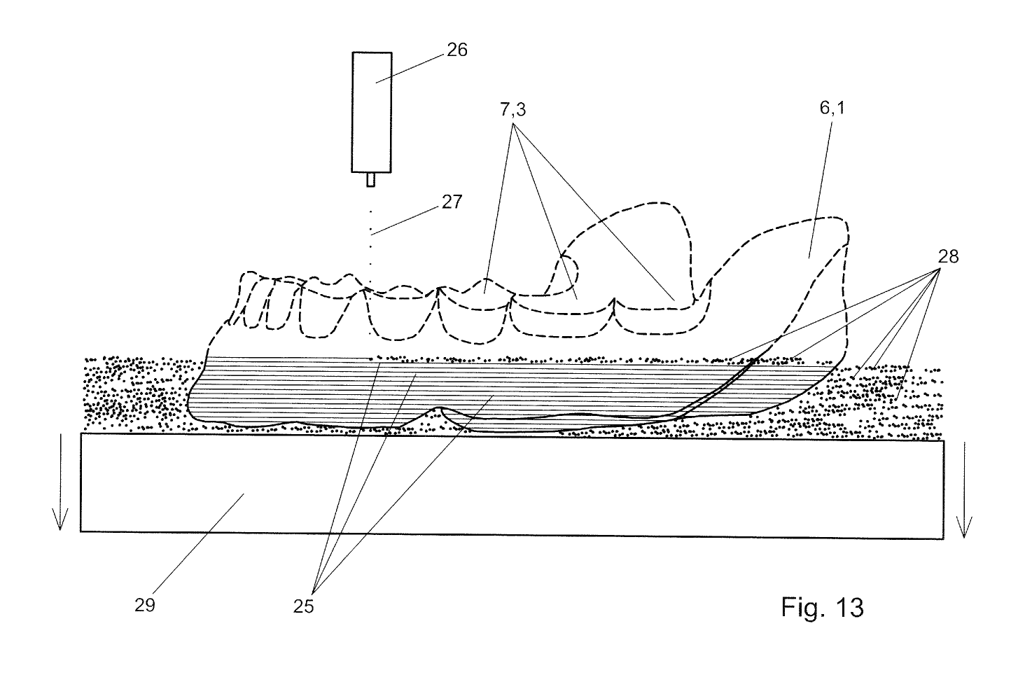

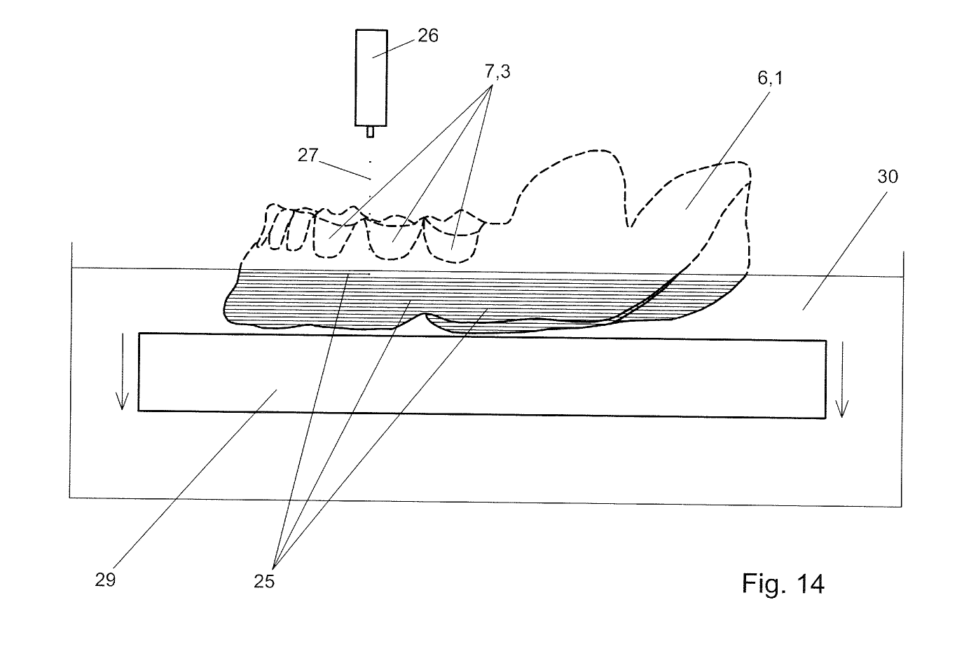

For the sake of completeness, suitable generative methods which are known per se from the prior art, and with which both the wax temporary prosthesis 6 and also the prosthesis base 1 can be produced, are shown schematically. FIG. 12 shows by way of example the production of a prosthesis base 1 or of a wax temporary prosthesis 6 by means of a 3D plotter or 3D printer known per se. The printer head 24 applies the successive layers 25 of the corresponding material, i.e. the wax or the plastic, and thus gradually creates the digitally stored or predetermined shape of the prosthesis base 1 or of the wax temporary prosthesis 6 with the corresponding prosthesis base receiving openings 3 or wax temporary prosthesis receiving openings 7. In FIG. 12, and also in FIGS. 13 and 14, the already applied layers 25 are shown by solid lines. The areas of the prosthesis base 1 or wax temporary prosthesis 6 that have not yet been produced, i.e. are still to be produced, are bounded by broken lines.

FIG. 13 shows by way of example the production of a prosthesis base 1 or of a wax temporary prosthesis 6 using a selective laser melting process which is likewise known per se. In this process, corresponding pellets or a corresponding powder 28 of the respective material, i.e. wax or plastic, are melted by the laser beam 27 of the laser light source 26. The layers 25 then form as hardening takes place. In methods such as that shown in FIG. 13, the wax temporary prosthesis 6 to be produced or the prosthesis base 1 to be produced is in most cases placed on a base plate 29 that can be lowered, such that the distance between the laser light source 26 and the layer 25 just to be prepared can be kept constant as the build-up of the layers increases. It is of course equally possible to raise the laser light source 26 accordingly. The individual layers 25 in any case arise, as in the case of the printer head 24 as per FIG. 12, in the areas to be produced.

FIG. 14 shows by way of example a third generative method that can be used to produce prosthesis base 1 or wax temporary prosthesis 6. Here, the laser beam 27 of the light source 26 is used such that resin or synthetic resin present in a bath 30 can be hardened at the appropriate places in order to form the corresponding layers 25 and thus, in the final analysis, the prosthesis base 1 or the wax temporary prosthesis 6. Here too, the component 1 or 6 to be produced is located on a base plate 29 that can be lowered in the bath 30, such that in this case too the distance between the laser light source 26 and the particular layer 25 to be produced is constant. In FIGS. 13 and 14 too, the areas of the prosthesis base 1 and of the wax temporary prosthesis 6 that are still to be produced by means of laser light source 26 and laser beam 27 are shown by broken lines. The layers 25 that have already been applied are shown by solid lines.

The possibility, according to the invention, of checking and optionally adapting the shape of the wax temporary prosthesis 6 before the preparation of the prosthesis base 1 is afforded in all of the variants of the method that have been described here.

FIGS. 4 and 5 and FIGS. 8 and 9 show full prostheses 2 for upper jaw and lower jaw, respectively. Partial prostheses for only partly edentulous upper and/or lower jaws are produced correspondingly and are not shown explicitly here.

### KEY TO THE REFERENCE NUMBERS

1 prosthesis base
2 full prosthesis
3 prosthesis base receiving opening
4 artificial tooth
5 milling machine
6 wax temporary prosthesis
7 wax temporary prosthesis receiving opening
8 casting mold
9 inner cavity
10 overflow opening
11 volume
12 housing
13 closure flap
14 control computer
15 machining cavity
16 pivot axis
17 pivot arm
18 securing device
19 rotation axis
20 tool
21 tool carrier head
22 upper mold half
23 lower mold half
24 printer head
25 layer
26 laser light source
27 laser beam
28 pellets or powder
29 base plate
30 bath

1. A method for producing a prosthesis base from plastic for a full or partial dental prosthesis, comprising producing the prosthesis base with prosthesis base receiving openings for artificial teeth using a digital data set that reflects a shape of the prosthesis base with the prosthesis base receiving openings, by first, on the basis of the digital data set, preparing a wax temporary prosthesis with corresponding wax temporary prosthesis receiving openings for the artificial teeth and then preparing the prosthesis base using the wax temporary prosthesis.

2. The method as claimed in claim 1, further comprising inserting the artificial teeth into the wax temporary prosthesis receiving openings before the prosthesis base is prepared.

3. The method as claimed in claim 2, wherein the prosthesis base with the artificial teeth inserted into the prosthesis base receiving openings is prepared using the wax temporary prosthesis with the artificial teeth inserted into the wax temporary prosthesis receiving openings.

4. The method as claimed in claim 1, further comprising using a casting process or a plugging process to produce the prosthesis base with or without the artificial teeth arranged in the prosthesis base receiving openings, using the wax temporary prosthesis with or without the artificial teeth arranged in the wax temporary prosthesis receiving openings.

5. The method as claimed in claim 2, further comprising producing a casting mold, using the wax temporary prosthesis with or without the artificial teeth arranged therein, the casting mold having an inner cavity that reflects an outer contour of the wax temporary prosthesis with or without the artificial teeth arranged in the wax temporary prosthesis receiving openings.

6. The method as claimed in claim 5, further comprising, after the casting mold has been produced, melting the wax temporary prosthesis in the casting mold and draining off the resulting liquid wax from the inner cavity via overflow openings of the casting mold.

7. The method as claimed in claim 6, wherein the wax temporary prosthesis with the artificial teeth arranged in the wax temporary prosthesis receiving openings is used to produce the casting mold, and the method further comprises maintaining the artificial teeth in position in the inner cavity by the casting mold during and after the draining of the liquid wax from the inner cavity.

8. The method as claimed in claim 6, further comprising filling a volume that has been freed in the inner cavity, after the liquid wax has been drained off, with the plastic in order to form the prosthesis base.

9. The method as claimed in claim 8, further comprising securing the artificial teeth in the prosthesis base as the volume that has become free is filled with the plastic, or inserting the artificial teeth into the prosthesis base receiving openings after the casting process for producing the prosthesis base.

10. The method as claimed in claim 1, further comprising shortening at least some of the artificial teeth, before their insertion into the wax temporary prosthesis receiving openings or the prosthesis base receiving openings, in their area that is to be arranged in the wax temporary prosthesis or in the prosthesis base.

11. The method as claimed in claim 5, further comprising, after the casting mold has been produced, removing the wax temporary prosthesis from the casting mold.

12. The method as claimed in claim 11, wherein the wax temporary prosthesis with the artificial teeth arranged in the wax temporary prosthesis receiving openings is used to produce the casting mold, and the method further comprises maintaining the artificial teeth in position in the inner cavity by the casting mold during and after the removal of the wax temporary prosthesis from the inner cavity.

13. The method as claimed in claim 12, further comprising filling a volume that has been freed in the inner cavity, after the wax temporary prosthesis has been removed, with the plastic in order to form the prosthesis base.
